(19) United States
(12) Patent Application Publication
(10) Pub. No.: US 2016/0162909 A1
(43) Pub. Date: Jun. 9, 2016

(54) AUTOMATIC MODIFICATION OF REQUIREMENTS BASED ON CONSUMPTION AND MARKET CHANGES

(71) Applicant: International Business Machines Corporation, Armonk, NY (US)

(72) Inventors: Rahul P. Akolkar, Austin, TX (US); Thomas E. Chefalas, Somers, NY (US); Jim A. Laredo, Katonah, NY (US); Chang-Shing Perng, Sunnyvale, CA (US); Anca Sailer, Scarsdale, NY (US); Frank A. Schaffa, Hartsdale, NY (US); Alla Segal, Mount Kisco, NY (US); Ignacio Silva-Lepe, Putnam Valley, NY (US); Tao Tao, Ossining, NY (US)

(21) Appl. No.: 14/563,104

(22) Filed: Dec. 8, 2014

(51) Int. Cl. G06Q 30/02; G06F 9/445

(52) U.S. Cl. CPC G06Q 30/0201; G06F 8/65

(57) ABSTRACT

A computer processor monitors a service marketplace and a deployed service application that includes one or more services based on a set of service requirements. The computer processor collects consumption data of the deployed service application and service marketplace information including change and trend information associated with the service marketplace. The computer processor analyzes the consumption data and the service marketplace information with respect to the set of service requirements, and the computer processor determines a gap between at least a requirement of the set of requirements and the consumption data, and a gap between at least a requirement of the set of requirements and the service marketplace information.

### BACKGROUND OF THE INVENTION

The present invention relates generally to online service requirements, and more particularly to identifying new and/or altered service requirements based on monitoring consumption of services and monitoring changes to a knowledgebase of marketplace available services.

Traditional application development involved iterative question and review sessions with customers, to accurately define requirements to meet customer needs and expectations. Application function code was often recreated for each customer requirement set. Recognition of commonly used code function led to re-use of code and offered development efficiencies. The advent of web-based applications and online web hosting providing online services, offered additional opportunities for efficiencies.

Solutions for services are typically driven by a particular customer's requirements; however, once a service solution is created the service may be re-used and made available to other potential customers. Service catalogs or registries are intended to store information to facilitate search and retrieval of services to match customer requirements. Numerous commercial web services directories and registries have been established as a foundation for a services marketplace. Many web services make use of the advanced features for search and categorization, which, for example can be found in specifications such as universal description, discovery and integration (UDDI). UDDI is a directory service in which businesses can register and search for web services. UDDI also provides a directory listing of web service interfaces described by web services description language (WSDL), which is a language for describing web services and how to access them.

Representational state transfer (REST) architecture has been applied to the development of web services as an alternative to other distributed computing specifications. Similarly, directories for services conforming to REST architecture have been established listing function and access information for application programming interfaces (APIs), which are used individually or in combinations in application development of service solutions. Services represented in directories and available for licensing can be viewed as a marketplace of services, and applications making use of marketplace services can significantly improve development cycles of service solutions.

### SUMMARY

According to one embodiment of the present invention, a method, computer program product, and system for generating service application requirements. A computer processor monitors a service marketplace and a deployed service application that includes one or more services based on a set of service requirements. The computer processor collects consumption data of the deployed service application and service marketplace information including change and trend information associated with the service marketplace. The computer processor analyzes the consumption data and the service marketplace information with respect to the set of service requirements, and the computer processor determines a gap between at least a requirement of the set of requirements and the consumption data, and a gap between at least a requirement of the set of requirements and the service marketplace information.

### BRIEF DESCRIPTION OF THE DRAWINGS

FIG. 1 is a functional block diagram depicting a distributed data processing environment, supporting a service solution life cycle, in accordance with an embodiment of the present invention.

FIG. 2 is a functional block diagram depicting operations associated with a life cycle of service solution generation, within the data processing environment of FIG. 1, in accordance with an embodiment of the present invention.

FIG. 3 illustrates operational activities of a service analysis program, inserted on a service server within the data processing environment of FIG. 1, in accordance with an embodiment of the present invention.

FIG. 4 depicts a block diagram of components of the service server computer executing the service analysis program, in accordance with an embodiment of the present invention.

### DETAILED DESCRIPTION

Embodiments of the present invention recognize that requirement-based service solutions, once delivered and in operation, often remain static and may be maintained but not improved. Embodiments of the present invention concurrently monitor and collect data associated with both the consumption of the delivered service solution, and the changes and trends occurring within the service marketplace. The collected data is analyzed, and compared and contrasted with current requirements of the delivered solution. Based on the solution consumption data and the service marketplace changes and trends data, some embodiments of the present invention generate recommended changes to existing requirements, which translates to improving the solutions to meet or exceed the original requirements. Additionally, new requirements may be generated indicating a need to develop or acquire new service offerings to meet demand of consumption behavior determined from current clients, or observed trends in the service marketplace.

Consumption monitoring includes determining client usage of application service components, features, time and duration of consumption, correlations between services and features. Consumption monitoring also includes measurement of capacity and performance based metrics of the solution's application components. In some embodiments of the present invention, key performance indicators (KPIs), which track measurable values reflecting attributes of key activities, may be included in the monitoring data. KPIs are often used to evaluate effectiveness in achieving targets. For example, a deployed service solution application may be monitored for the number of times a particular service component of the service application is invoked by users. The data may be used in conjunction with user IDs to determine usage coverage, or in conjunction with time measurements to determine frequency, duration, and volume of use. Other embodiments may monitor availability of access, performance of the service, or any combination of consumption related monitoring metrics.

The service marketplace provides services to consumers, which are clients to providers of service solutions. The service marketplace may include dynamic additions and changes to service offerings. The service marketplace may also include particular behaviors from consumers of services, which include trends of services in demand and out of favor, new service offerings, updates to existing services, the types of services updated, and the features associated with the updates. Embodiments of the present invention monitor service marketplace trends, changes, consumer preferences, and consumer behaviors, relative to offered services, to obtain marketplace-specific data. The consumption and marketplace data are analyzed and compared to the current requirements of a client solution and determination made of modified requirements and/or new requirements that may provide a better fit to the consumption behavior of clients. Additionally marketplace monitoring data may provide recommendations of requirement modification and/or new requirements aligning with marketplace trends, consumer demand, improved efficiency, and novel features of a service.

Embodiments of the present invention add a continuously improving element to the life cycle of service solutions. Continuous improvement is enabled by determining recommendations for changes to existing requirements and new service requirements, based on the comparison of the analysis of the current service solution consumption monitoring data and the service marketplace monitoring data, to the requirements associated with current service solutions.

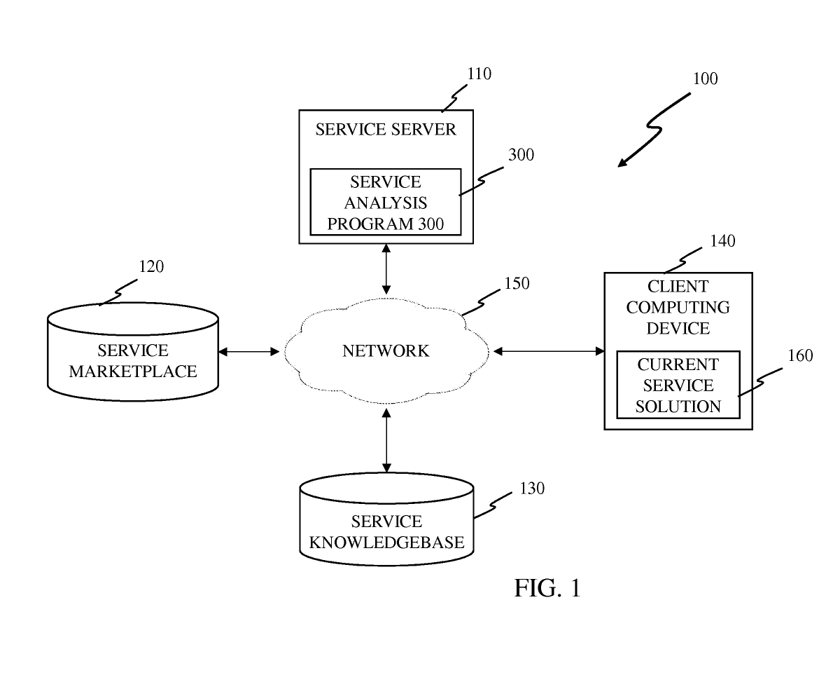

The present invention will now be described in detail with reference to the Figures. FIG. 1 is a functional block diagram illustrating an example of a distributed computer processing environment, generally designated 100, supporting a service solution life cycle, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed computer processing environment 100 includes service server 110, which is depicted as hosting service analysis program 300, service marketplace 120, service knowledgebase 130, and client computing device 140, which includes current service solution 160, all interconnected through network 150.

Network 150 can be, for example, a local area network (LAN), a telecommunications network, a wide area network (WAN), such as the Internet, a virtual local area network (VLAN), or any combination that can include wired, wireless, or optical connections. In general, network 150 can be any combination of connections and protocols that will support communications between service server 110, service marketplace 120, service knowledgebase 130, and client computing device 140, the operation of current service solution 160, and the operation of service analysis program 300, in accordance with embodiments of the present invention.

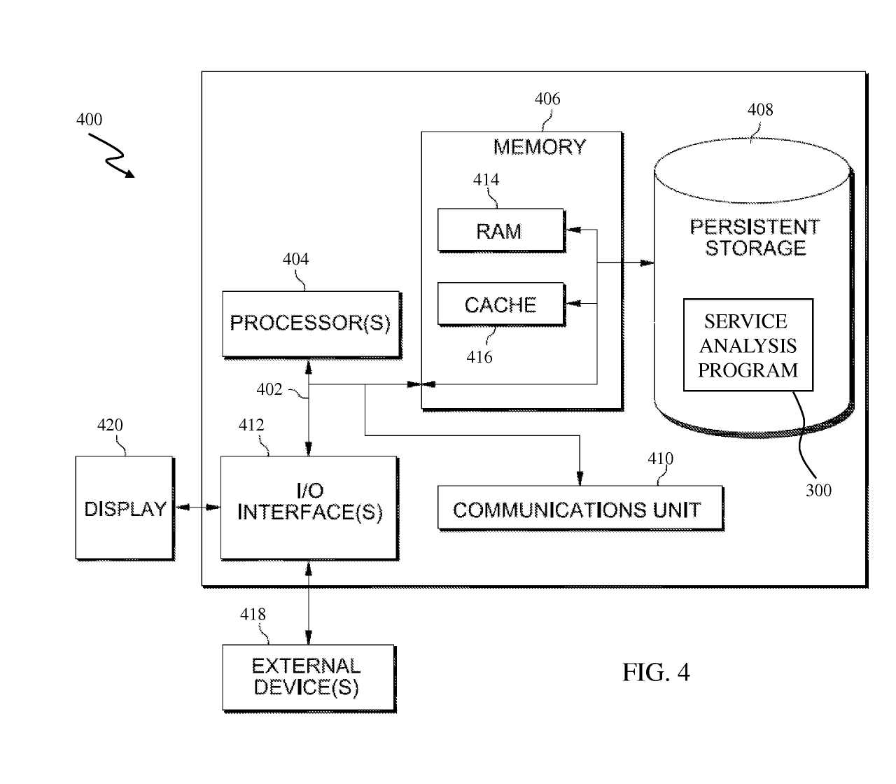

Client computing device 140 is a consumer of services and operates current service solution 160. In some embodiments of the present invention, client computing device 140 may be one of a plurality of computing devices of an enterprise organization, consuming particular service functions of current service solution 160. The activities associated client computing device 140, such as invoking marketplace services integrated into current service solution 160, may be monitored by service analysis program 300 and stored for analysis on service server 110, for example, or stored in service knowledgebase 130. Client computing device 140 may be a desktop computer, a laptop computer, netbook computer, a personal computer (PC), a tablet computer, a web server, a mobile computing device, a personal digital assistance (PDA), a smart phone, or any programmable electronic device capable of communicating with service server 110, service marketplace 120, and service analysis program 300, via network 150. In other embodiments, client computing device 140 may represent a virtual computing device of a computing system utilizing multiple computers as a server system, such as in a cloud computing environment. In another embodiment, client computing device 140 represents a computing system utilizing clustered computers and components (e.g., database server computers, application server computers, etc.) that act as a single pool of seamless resources when accessed within distributed processing environment 100. Client computing device 140 may include internal and external hardware components, as depicted and described with reference to FIG. 4.

Current service solution 160 is a service application that includes services available from service marketplace 120, and may include custom developed service components. The development of current service solution 160 follows a series of activities in which client requirements are determined along with system requirements that may include development best practices, governance guidance, and compliance requirements. The consolidated requirements are reviewed and refined, and are assessed against available service offerings in a service marketplace, such as service marketplace 120. Information regarding service marketplace service offerings is gathered and stored in service knowledgebase 130. The client requirements are mined in service knowledgebase 130 for potential matches. Available services matching client requirements are integrated into a service solution that may include one or more services from service marketplace 120. In cases in which the client service requirements are not matched in available service offerings of service marketplace 120, custom solutions are developed. The custom developed services along with any services matching client requirements from service marketplace 120, are integrated into current service solution 160. In one embodiment of the present invention, current service solution 160 may be deployed on a client computing device as depicted on client computing device 140. In other embodiments, current service solution 160 may be deployed on a web application server, such as service server 110, and accessed via network 150.

Service knowledgebase 130 includes information associated with service marketplace 120 and the service offerings available in service marketplace 120. For example, service knowledgebase 130 includes identification of the service offerings available in service marketplace 120, and categorizes the services by type and related metadata. The information regarding a service offering also includes, for example, access links to a description of the service and details regarding access and integration of the service into service solution applications. The information of available services also includes the version designation, when the service became available, features of the service, and other services with which it interacts. Service knowledgebase 130 also includes information regarding the number of times a particular service is requested by service solution providers.

Service marketplace 120 is a database of service offerings that may be searched to locate a particular service and determine the service description as well as information to access and use the service offerings. Services accessed from service marketplace, by service solution providers, may be included within a service solution to provide particular service function and features as an alternative to re-creating the same or similar function independently. Service solution providers benefit from using available service offerings from service marketplace 120 by reducing development time, testing time, and avoiding the costs and efforts associated with ongoing support of custom developed service functions. Service marketplace 120 is a dynamic entity, in which new service offerings are added over time, as well as new-version updates replacing existing versions of services. In some cases services may be removed from service marketplace 120.

Service server 110 is a computing device that includes service analysis program 300, and is capable of operating program 300 within distributed computer processing environment 100. In some embodiments service server 110 may be a management server, a web server, a mobile computing device, or any other electronic device or computing system capable of receiving and sending data. In other embodiments, service server 110 may represent a virtual computing device of a computing system utilizing multiple computers as a server system, such as in a cloud computing environment. In another embodiment, service server 110 may be a laptop computer, a tablet computer, a netbook computer, a personal computer (PC), a desktop computer, a personal digital assistant (PDA), a smart phone, or any programmable electronic device capable of performing consumption monitoring of web based services and service marketplace changes and updates, via network 150. In another embodiment, service server 110 represents a computing system utilizing clustered computers and components (e.g., database server computers, application server computers, etc.) that act as a single pool of seamless resources when accessed within distributed computer processing environment 100. Service server 110 may include internal and external hardware components, as depicted and described with reference to FIG. 4.

Service analysis program 300 is an application that adds a continuous improvement attribute to the life cycle of deployed service solutions, such as current service solution 160. Service analysis program 300 monitoring the consumption of the deployed service solutions and the changes to and trends of the service marketplace, and based on comparison of the analysis to the current solution requirements, determines new or altered requirements that better fit the client behavior as determined by monitoring consumption of the services. In addition, service analysis program 300 determines if the service marketplace offers solutions that provide improvements to the client's needs or the provider's offerings, or if monitoring of the service marketplace indicates trends suggesting new requirements to be considered by service providers and clients.

Data obtained by service analysis program 300 from monitoring the client consumption of a deployed service solution instance, can be used to compare the actual usage of the service solution requirements by the client to the requirements originally approved by the client. For example, service analysis program 300 monitors current service solution 160 and determines that service A, with features 1 and 2, is invoked with a very high frequency of calls throughout normal business hours; however, feature 1 is almost exclusively used, with feature 2 almost completely idle. Service analysis program 300 determines that feature 2 may possibly be removed or at least reduced in support, with additional focus and support for feature 1 of service A. Service analysis program 300 generates a recommended change to requirements associated with service A to reflect the result of client consumption monitoring.

In another example, services J, K, and L were integrated from service marketplace 120 and included in current service solution 160. At the time of solution development, additional requirements could not be matched with available service offerings available in service marketplace 120, and were custom developed as service X and included in current service solution 160. Over time, service analysis program 300 monitors service marketplace 120 and determines that service offering M is a new service offering added to service marketplace 120 and combines the service functions of X and L. In addition, service analysis program 300 determines a trend in service marketplace 120 in which consumers have shown a growing demand for service G, which matches the function and features of service J, which is declining in demand, and handles higher demand loads with lower unit cost. Service analysis program 300, after comparing the monitoring data of service marketplace 120 to current service solution 160 requirements, determines that service M can replace services L and custom service X, and reduce the provider's cost and effort of maintaining customer service X. Service analysis program 300 also determines that service G may replace service J and provide additional benefits and lower cost. Service analysis program 300 generates altered or new requirements to reflect the potential improvements of service delivery based on the comparison of consumption and marketplace monitoring data, compared to current service solution 160 requirements.

Differences determined between the actual usage behavior of the client and the original approved requirements may be used by both the client and service provider to improve the match of client service needs to service solutions. In one embodiment of the present invention, service analysis program 300 is used by providers to identify marketplace trends and obtain recommendations of new and altered requirements that can reduce development and maintenance costs, reduce operational issues, and/or provide enhanced service solutions that better fit client actual consumption-based requirements.

In another embodiment, service analysis program 300 is used by clients to inform the client of opportunities to change requirements to better meet actual client needs, focusing on high usage requirements and reducing or eliminating focus on low use requirements. The requirements generated by service analysis 300 may be used to adjust requirement sets and negotiate a more focused service contract with providers.

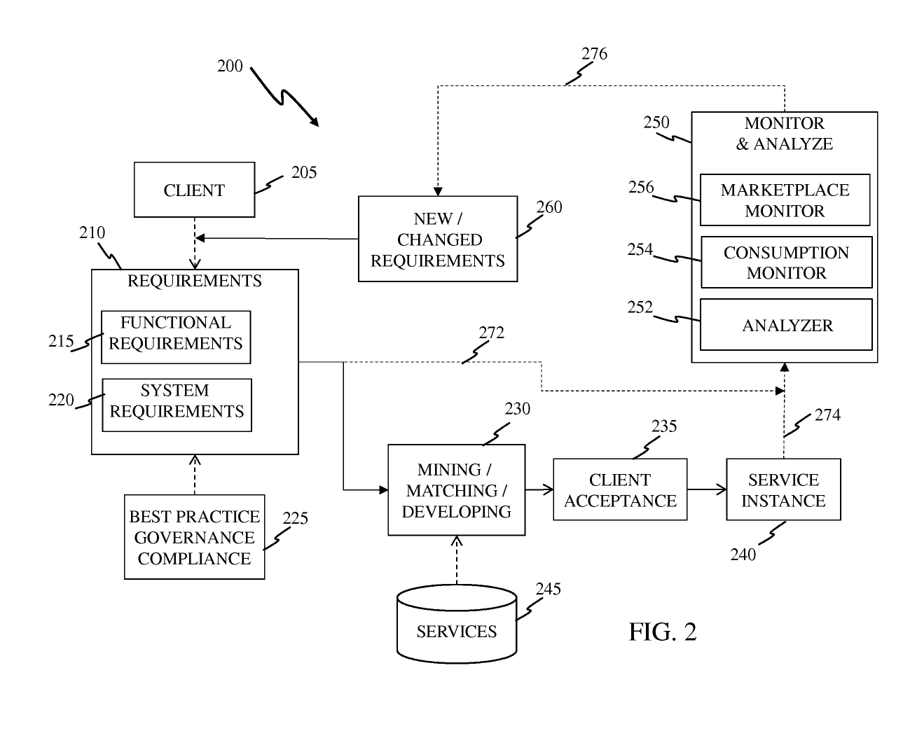

FIG. 2 is a functional block diagram depicting example operations 200 associated with a life cycle of service solution generation, within the data processing environment of FIG. 1, in accordance with an embodiment of the present invention. Embodiments of the present invention monitor and analyze the consumption of deployed service instances over a particular period of time. Embodiments also monitor and analyze the changes and trends observed in the service marketplace or recorded in the service knowledgebase, over corresponding periods of time. The deployed service instances are based on activities that determine requirements for a particular service application instance, and generate solutions for the requirements of the particular service application instance. Embodiments of the present invention recognize that client service application instances are often maintained until the service is no longer needed or the contractual agreement between provider and client expires, with minimal activity to improve the service instance over time. Embodiments of the present invention introduce activities of monitoring, data collection, analysis of data, and recommendation of new or adjusted requirements offering improvement to the existing (current) service application instance, thus including a continual improvement component to the service application life cycle.

Service application instances include activities in which client 205 inputs functional requirements 215 for the proposed service application instance. Based on supporting functional requirements 215 that are submitted, system requirements 220 are determined. System requirements 220 include input from best practices, governance guidance, and compliance rules 225. The total input of functional and system requirements are included in requirements 210, and are assessed and refined until a final set of requirements are agreed upon by the client and service provider.

The agreed upon requirements are then matched against services 245 which represents service offerings available in a service marketplace. Providers can mine the service marketplace services for services matching client requirements, and include the marketplace services within the overall client solution, for example, by licensing a marketplace service and using published application programming interface (API) information to access the service from the application solution. Activities of mining, matching, and developing 230 are performed to determine the marketplace services that can provide client requirements, and the matching services are included in the solution application. Requirements for which marketplace services are not found or matched, the requirement is custom developed by the provider as part of the solution application. Custom developed services may be included as a general offering for subsequent clients, or may be published in a services marketplace for general licensing availability.

The service solution is reviewed and proceeds following client acceptance 235 and the service solution application is deployed as service instance 240. Service instance 240 continues to operate over time and in embodiments of the present invention, the consumption of services and features of the services is monitored by consumption monitor 254, and data is collected as indicated by dashed line 274. Monitoring the consumption of service instance 240 includes, for example, monitoring the number of times each service element of service instance 240 is invoked, the duration of each invocation, utilization of each element of service instance 240, response time, usage as a function of time-of-day, and correlations between services or features within service instance 240. In some embodiments of the present invention, key process indicators (KPIs) may be used to quantify consumption monitoring. KPIs are measurable values that demonstrate effectiveness in achieving objectives. KPIs are used to evaluate levels of reaching or approaching targets.

Monitor and analyze 250, includes monitoring and analysis of the consumption of service instance 240 and changes and trends of the service marketplace. As service instance 240 continues to operate over time, marketplace monitor 256 monitors the service marketplace and knowledgebase to determine changes and trends. As new services are added to the services marketplace, and as existing versions are updated with improved performance or added features, marketplace monitor 256 collects data associated with the changes. Additionally, marketplace monitor 256 determines trends associated with the service marketplace, which is indicated, for example, by patterns of service demand, additions of new services of a particular or related type, and updates and changes to existing service offerings.

Analyzer 252 receives data from consumption monitor 254 and marketplace monitor 256 and input from the requirements of service instance 240 as indicated by dashed line 272. Analyzer 252 compares the consumption data, and change and trend data, to the requirements of the solution deployed and operating in service instance 240, and determines whether there is a gap of adequate significance to recommend changes to existing requirements. Recommending changes to requirements may result in a better match between the client's actual consumption of services and the requirements on which service instance 240 is based. Analyzer 252 also compares the changes and trends of the service marketplace and service knowledgebase to the requirements on which service instance 240 is based.

Results of analyzer 252 are received by new/changed requirements 260, as indicated by dashed line 276, and in some embodiments of the present invention, recommended changes to requirements and new requirements are fed into requirements 210 as a basis to consider improvement to service instance 240, and serves to continue the life cycle of the client's service solution. In some embodiments of the present invention, a gap threshold representing a degree of differentiation between the requirements of the current service solution, such as service instance 240, and the results of analyzing the data from the consumption of services and the changes and trends observed in the service marketplace. In some embodiments KPI thresholds may be pre-determined for consumption metrics that are monitored. Similarly, KPI thresholds may be pre-determined for changes to the service marketplace, overall or in a particular service area. Trend data measuring pattern growth or pattern changes may have pre-determined thresholds defined. If monitoring data exceeds a threshold, some embodiments determine that a gap of significant magnitude exists, and a requirement change or a new requirement is recommended.

In some embodiments of the present invention, the analysis of monitoring data from the consumption of the current services solution and monitoring of the service marketplace and knowledge base includes use of a semantic learning model to analyze and compare both documented requirements of the current service solution, and documented details of services in the marketplace to determine gaps or improved replacement opportunities. Additionally, semantic models may be augmented or replaced with the use of natural language processing methods and tools.

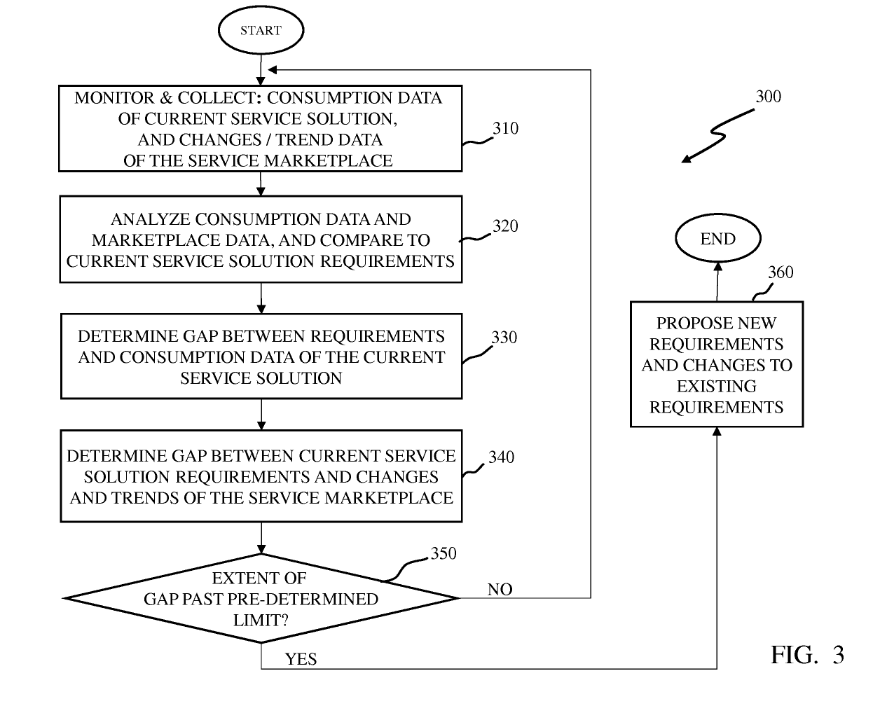

It should be noted that FIG. 2 depicts example activities associated with a life cycle of a service instance generation. The life cycle includes example activities in which embodiments of the present invention offer opportunities to improve the match between client service requirements, as indicated by client consumption of services, and offerings of the service marketplace, based on the changes and trends observed. In some embodiments of the present invention, the activities associated with monitor and analyze 250, marketplace monitor 256, consumption monitor 254, and analyzer 252 are performed by service analysis program 300, discussed further with regard to FIG. 3.

FIG. 3 illustrates operational activities of service analysis program 300 inserted on service server 110, within distributed data processing environment 100 of FIG. 1, in accordance with an embodiment of the present invention. Service analysis program 300 monitors and collects the consumption data of the current service solution, and monitors and collects data for the changes and trends of the service marketplace (step 310). In some embodiments of the present invention, the current service solution includes one or more service offerings from a service marketplace, in which services are published and may be licensed by service solution providers to include in application solutions being developed. Marketplace services are accessible by designated APIs, and as such the invocation or “call” to the API can be monitored, and data associated with the API can be collected. For example, the number of cumulative calls to an API, the number of calls per unit time, the duration of calls, the time of day calls to the API are made, can all be monitored and the corresponding data stored for analysis. In some embodiments, monitoring and data collection of the service marketplace and service knowledgebase includes, for example, tracking changes and updates to existing service offerings, additions of new offerings, noting the type or area of the offering changed or added, determining positive and negative feedback associated with service offerings, and determining the types of changes to the marketplace (or knowledgebase) as a function of time. The corresponding data from monitoring can be stored for analysis.

Having acquired adequate consumption and service marketplace monitoring data, service analysis program 300 analyzes the consumption data and the marketplace data, and compares the data to the current service solution requirements (step 320). The analysis of the current service solution consumption data indicates the demand of service functions and features as well as attributes of the demand, such as time, time of day, time of year, and correlations with other services. Service consumption may align or differ from the client approved requirements on which the current service solution is based.

The data resulting from monitoring the service marketplace is compared to the requirements of the current service solution to determine if new service offerings or updates to existing service offerings have been added to the service marketplace, and whether the changes to the marketplace correspond to the requirements of the current service solution. In some embodiments of the present invention, the analysis of requirements and monitoring data include parsing of the content, and key word/key phrase matching to determine relevance of a requirement to monitored data. In other embodiments, KPIs may be defined and associated with particular requirements of the current service solution. In yet other embodiments, semantic models developed with combinations of supervised and unsupervised learning, or natural language process models, may be used to determine correspondence of service marketplace changes and trends with current service solution requirements.

Service analysis program 300 determines the gap between the requirements and the consumption data of the current service solution (step 330). Differences between the solution requirements and the consumption data indicate a potential mismatch or opportunity for improving the current service solution to more closely match the demonstrated usage. In some embodiments, consumption of a service or feature of a service may indicate low usage; however, requirements may indicate equal weight of importance of all services. The low usage service or feature may be candidate for removal. In other embodiments, a service may experience high demand at a particular time of day and experience reduced response time due to the level of demand. In yet other embodiments, a first service may consistently be invoked in connection with use of a second service; however no such correlation is considered in the requirements.

Service analysis program 300 determines the gap between the current service solution requirements and the changes and trends of the service marketplace (step 340). Changes to the service marketplace may include offerings that were not available during development of the current service solution. Trends in the marketplace may indicate consumers moving towards service offerings that combine multiple services into a single offering. Comparing requirements of the current service solution to the changes and trends of the service marketplace, monitored over time, service analysis program 300 determines a gap. For example, in some embodiments, service marketplace monitoring indicates that offerings corresponding to requirements are available that can replace custom developed services and combine multiple services into a single service. Changes to service marketplace offerings may provide superior solutions, replace custom developed services, or offer multiple services in a single service offering. Consideration of the changes to the marketplace corresponding to requirements of the current service solution may offer improvement in one or more areas of performance, cost, efficiency, reliability, and security.

In some embodiments of the present invention, comparison, by service analysis program 300, between service consumption data and requirements or marketplace changes and trends, and requirements, results in the determination of gaps. In other embodiments, it is acknowledged that service analysis program 300 may determine there are no gaps. It should be noted that the order of performing steps 330 and 340 is arbitrary and the associated activities may be performed separately or in combination.

Having determined the gaps that may exist between the requirements of the current service solution, and service consumption data and marketplace change and trend data, service analysis program 300 determines if the extent of gaps between analyzed data and requirements exceeds a pre-determined threshold (decision step 350). Determining if the extent of gaps extends past a pre-determined threshold may include, for example, determining if one or more KPIs associated with a service or features of a service, extends past a pre-determined KPI target. In another example, determining the extent of the gaps between the current service solution requirements and the monitoring data from service consumption and marketplace changes, may include locating a service marketplace offering that replaces a custom developed service, and/or determining a number of instances in which consumers selected a new marketplace service that extends past a pre-determined limit of consumer selection.

Having determined that the extent of the gaps does not extend past a pre-determined limit (step 350, “NO” branch), service analysis program 300 returns to monitor and collect consumption data of the current service solution, and monitor and collect changes and trend data of the service marketplace and knowledgebase (step 310) and proceeds as described above.

Having determined that the extent of the gaps does extend past a pre-determined limit (step 350, “YES” branch), service analysis program 300 proposes new requirements and changes to existing requirements (step 360). In one embodiment of the present invention, service analysis program 300 quantifies a gap between a current service solution requirement and consumption data of the current solution. The quantification may be a count of monitored activity, such as the number of invocations, or calls, to the API of a particular marketplace service, or a time-related metric, such as the average duration of a service call, or average response time per time-of-day. The quantification may include a cumulative count of the gaps identified, or may be, may involve a correlation between services or activities associated with services. Service analysis program 300 compares the quantification to a pre-determined limit and if the quantification extends past the limit, service analysis program 300 proposes changes to existing service solution requirements. Similarly, if service analysis program 300 determines changes and trends associated with the service marketplace and/or the service knowledge base, the changes and/or trends are quantified. The quantified changes and/or trends are compared to a pre-determined limit of changes and trends, and if the quantification extends past the limit, service analysis program 300 proposes new requirements.

For example, service analysis program 300 monitors the service marketplace 120 and knowledge base 130 for changes and trends. Service analysis program 300 also monitors the consumption of deployed current service solution 160, which includes the integration of services (S1) of A, B, and C, from service marketplace 120, and custom developed service X. The integrated services, S1, of current service solution 160 are based on requirements a, b, c, and d, and requirement “a” includes feature 1 and feature 2. Service analysis program 300 determines gaps between the requirements and consumption of current service solution 160, which include no usage of feature 2 of requirement A, and response time issues when requirement B and C are operating concurrently. Additionally, service analysis program 300 determines that service marketplace 120 now includes service M, which performs the functions of custom developed service X, and knowledge base 130 includes trending data in which consumers are favoring service P in place of service C, which reduces the response time when concurrently operating with service B.

Service analysis program 300 proposes that requirement “a” be changed to exclude feature 2, and proposes new requirements m and p, to integrate new services M and P; replacing services X and C respectively, in a proposed new solution. In the current example, service analysis program 300 includes the proposed requirement changes and additions in a report file and notifies the user of the proposal.

In some embodiments, service analysis program 300 may propose new requirements based on gaps determined between the consumption of the current services solution and the solution requirements. In other embodiments, service analysis program 300 may propose changes to existing solution requirements based on changes and/or trends determined in the services marketplace or service knowledge base.

In other embodiments of the present invention, one or more determined gaps between current solution requirements and monitored solution consumption may not be quantified, and the use of pre-determined limits associated with the extent of a gap between the current service solution consumption and the solution's requirements may be omitted. In such embodiments, service analysis program 300 proposes changes to existing requirements or new requirements based on determining a gap, without consideration of the extent of the gap. In some embodiments, the proposed changes to existing requirements and new requirements are presented to the user in a form of a report or file that can be viewed, printed, stored, and included in communications.

Having proposed changes to existing requirements and/or new requirements, service analysis program ends.

FIG. 4 depicts a block diagram of components of computing device 400 capable of executing service analysis program 300, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Computing device 400, as well as service server 110 and client computing device 140, include communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Service analysis program 300 is stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of distributed computer processing environment 100. In these examples, communications unit 410 includes one or more network interface cards. Communications unit 410 may provide communications through the use of either or both physical and wireless communications links. Service analysis program 300 may be downloaded to persistent storage 408 through communications unit 410.

I/O interface(s) 412 allows for input and output of data with other devices that may be connected to computing device 400, service server 110, and client computing device 140. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., service analysis program 300 can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for generating service application requirements, the method comprising:
a processor, monitoring a service marketplace and a deployed service application that includes one or more services based on a set of service requirements;
the processor, collecting consumption data of the deployed service application and service marketplace information including change and trend information associated with the service marketplace;
the processor, analyzing the consumption data and the service marketplace information with respect to the set of service requirements; and
the processor, determining a first gap between at least a requirement of the set of requirements and the consumption data, and a second gap between at least a requirement of the set of requirements and the service marketplace information.

2. The method of claim 1, wherein collecting service marketplace information includes usage, trends, new function, and changes associated with the services of the service marketplace.

3. The method of claim 1, wherein the one or more services are integrated into the deployed service application by use of application programming interfaces (APIs).

4. The method of claim 1, further comprising:
the processor, determining if the first gap between at least a requirement of the set of requirements of the deployed service application and the consumption data that is analyzed, exceeds a pre-determined target;
the processor, determining if the second gap between at least a requirement of the set of requirements of the deployed service application and the information associated with the service marketplace, exceeds a pre-determined target; and
in response to one or both of the first gap and the second gap exceeding the pre-determined target, the processor, generating recommended requirements automatically, which include at least one of: changes to the set of requirements of the deployed service application and new requirements.

5. The method of claim 1, wherein determining the first gap between the set of requirements of the deployed service application and the consumption data of the one or more services of the deployed service application, and the second gap between the set of requirements of the deployed service application and the information associated with the service marketplace, includes analysis of key process indicators (KPIs) of the deployed service application.

6. The method of claim 1, wherein determining the first gap between the set of requirements of the deployed service application, and the data of the consumption of the one or more services of the deployed service application, and the second gap between the set of requirements of the deployed service application and the information associated with the service marketplace, results in a generation of a set of new requirements.

7. The method of claim 1, wherein determining the first gap between the requirements of the deployed service application, and the data of the consumption of the one or more services of the deployed service application and the second gap between the set of requirements of the deployed service application and the information associated with the service marketplace, results in a generation of a set changes to existing requirements of the deployed service application.

8. A computer program product for generating service application requirements, the computer program product comprising:
a computer readable storage medium having program instructions embodied therewith, wherein the program instructions are executable by a computer processor to cause the computer processor to perform a method comprising:
monitoring, by a processor, a service marketplace and a deployed service application that includes one or more services based on a set of service requirements;
collecting, by the processor, consumption data of the deployed service application and service marketplace information including change and trend information associated with the service marketplace;
analyzing, by the processor, the consumption data and the service marketplace information with respect to the set of service requirements; and
determining, by the processor, a first gap between at least a requirement of the set of requirements and the consumption data, and a second gap between at least a requirement of the set of requirements and the service marketplace information.

9. The computer program product of claim 8, wherein collecting service marketplace information includes usage, trends, new function, and changes associated with the services of the service marketplace.

10. The computer program product of claim 8, wherein the one or more services are integrated into the deployed service application by use of application programming interfaces (APIs).

11. The computer program product of claim 8, further comprising:
determining, by the processor, if the first gap between at least a requirement of the set of requirements of the deployed service application and the consumption data that is analyzed, exceeds a pre-determined target;
determining, by the processor, if the second gap between at least a requirement of the set of requirements of the deployed service application and the information associated with the service marketplace, exceeds a pre-determined target; and
in response to one or both of the first gap and the second gap exceeding the pre-determined target, the processor, generating recommended requirements automatically, which include at least one of: changes to the set of requirements of the deployed service application and new requirements.

12. The computer program product of claim 8, wherein determining the first gap between the set of requirements of the deployed service application and the consumption data of the one or more services of the deployed service application, and the second gap between the set of requirements of the deployed service application and the information associated with the service marketplace, includes analysis of key process indicators (KPIs) of the deployed service application.

13. The computer program product of claim 8, wherein determining the gap between the set of requirements of the deployed service application, and the data of the consumption of the one or more services of the deployed service application, and the gap between the set of requirements of the deployed service application and the information associated with the service marketplace, results in a generation of a set of new requirements.

14. The computer program product of claim 8, wherein determining the gap between the requirements of the deployed service application, and the data of the consumption of the one or more services of the deployed service application and the second gap between the set of requirements of the deployed service application and the information associated with the service marketplace, results in a generation of a set changes to existing requirements of the deployed service application.

15. A computer system for generating service application requirements, the computer system comprising:
one or more computer processors;
one or more computer readable storage media; and
program instructions stored on the computer readable storage media for execution by at least one of the one or more processors, the program instructions comprising:
program instructions to monitor a service marketplace and a deployed service application that includes one or more services based on a set of service requirements;
program instructions to collect consumption data of the deployed service application and service marketplace information including change and trend information associated with the service marketplace;
program instructions to analyze the consumption data and the service marketplace information with respect to the set of service requirements; and
program instructions to determine a first gap between at least a requirement of the set of requirements and the consumption data, and a second gap between at least a requirement of the set of requirements and the service marketplace information.

16. The computer system of claim 15, wherein the one or more services are integrated into the deployed service application by use of application programming interfaces (APIs).

17. The computer system of claim 15, further comprising:
program instructions to determine if the first gap between at least a requirement of the set of requirements of the deployed service application and the consumption data that is analyzed, exceeds a pre-determined target;
program instructions to determine if the second gap between at least a requirement of the set of requirements of the deployed service application and the information associated with the service marketplace, exceeds a pre-determined target; and
in response to one or both of the first gap and the second gap exceeding the pre-determined target, program instructions to generate recommended requirements automatically, which include at least one of: changes to the set of requirements of the deployed service application and new requirements.

18. The computer system of claim 15, wherein determining the first gap between the set of requirements of the deployed service application and the consumption data of the one or more services of the deployed service application, and the second gap between the set of requirements of the deployed service application and the service marketplace information, includes analysis of key process indicators (KPIs) of the deployed service application.

19. The computer system of claim 15, wherein determining the first gap between the set of requirements of the deployed service application, and the data of the consumption of the one or more services of the deployed service application, and the second gap between the set of requirements of the deployed service application and the information associated with the service marketplace, results in a generation of a set of new requirements.

20. The computer system of claim 15, wherein determining the first gap between the requirements of the deployed service application, and the data of the consumption of the one or more services of the deployed service application and the information associated with the service marketplace, results in a generation of a set changes to existing requirements of the deployed service application.
